(19) United States
(12) Patent Application Publication
(10) Pub. No.: US 2025/0124566 A1
(43) Pub. Date: Apr. 17, 2025

(54) Defect Inspection System and Defect Inspection Method

(71) Applicant: Hitachi High-Tech Corporation, Tokyo (JP)

(72) Inventors: Takehiro MAEDA, Tokyo (JP); Minoru HARADA, Tokyo (JP); Hajime KAWANO, Tokyo (JP); Takehiro HIRAI, Tokyo (JP)

(21) Appl. No.: 18/898,866

(22) Filed: Sep. 27, 2024

(30) Foreign Application Priority Data
Oct. 16, 2023 (JP) 2023-178067

(51) Int. Cl. G06T 7/00; G06V 10/75

(52) U.S. Cl. CPC G06T 7/001; G06V 10/751; G06T 2207/10061; G06T 2207/20081

(57) ABSTRACT

Provided is a defect inspection system 1 having an imaging device 100 for acquiring an observation image of a sample 107, including a learning unit 330a that trains a multiple non-defective product image estimation model 401 that captures an image of the sample 107 to acquire a learning image and estimates a plurality of non-defective product images of the sample 107 for one input image using the learning image, and a defect inspection unit 330b that captures an image of an inspection target sample using the imaging device 100 to acquire an inspection target image 1000, inputs the inspection target image 1000 into the multiple non-defective product image estimation model 401 trained, outputs a plurality of estimated non-defective product images 440 corresponding to the inspection target image 1000, and extracts a defective part using the plurality of estimated non-defective product images 440.

### CLAIM OF PRIORITY

The present application claims priority from Japanese Patent application serial No. 2023-178067, filed on Oct. 16, 2023, the content of which is hereby incorporated by reference into this application.

### BACKGROUND OF THE INVENTION

### 1. Field of the Invention

The present invention relates to a defect inspection system and a defect inspection method.

### 2. Description of Related Art

JP2021-140739A is a background art of this technical field. JP2021-140739A describes that “a computer executes a process of accepting a selection of either a learning mode or an operation mode, acquiring a learning image including an inspection target object when the learning mode is selected, accepting settings of hyperparameters of a first learning model generated by unsupervised learning, generating the first learning model that outputs a reconstructed image corresponding to the learning image when the acquired learning image is input based on the accepted hyperparameters, acquiring an inspection image including the inspection target object, accepting settings of an abnormality degree threshold for verifying the inspection image, calculating an abnormality degree between the acquired inspection image and the reconstructed image output by the trained first learning model, and displaying a detected abnormal image based on the calculated abnormality degree and the accepted abnormality degree threshold.”.

However, in JP2021-140739A, a model that outputs a reconstructed image corresponding to an input image is generated by unsupervised learning, and image inspection is performed using the inspection image and the reconstructed image. A deep learning model including a Variational Auto Encoder (VAE) described in an embodiment of JP2021-140739A includes random processing in a process of learning internal parameters. Therefore, even when the same image dataset is used for learning, the internal parameters obtained after learning differ for each model. As a result, when a trained model is used for inspection, there is a risk that an inspection result will vary depending on a learning result of each model.

### SUMMARY OF THE INVENTION

Therefore, the invention provides a defect inspection system and a defect inspection processing method that are capable of obtaining an inspection result with good reproducibility.

In order to solve the above-described problem, a defect inspection system according to the invention is a defect inspection system having an imaging device for acquiring an observation image of a sample, including a learning unit that trains a multiple non-defective product image estimation model that captures an image of the sample to acquire a learning image and estimates a plurality of non-defective product images of the sample for one input image using the learning image, and a defect inspection unit that captures an image of an inspection target sample using the imaging device to acquire an inspection target image, inputs the inspection target image into the multiple non-defective product image estimation model trained, outputs a plurality of estimated non-defective product images corresponding to the inspection target image, and extracts a defective part using the plurality of estimated non-defective product images.

A defect inspection method according to the invention is a defect inspection method for a defect inspection system having an imaging device for acquiring an observation image of a sample, including the steps of training, with a learning unit, a multiple non-defective product image estimation model that captures an image of the sample to acquire a learning image and estimates a plurality of non-defective product images of the sample for one input image using the learning image, and capturing, with a defect inspection unit, an image of an inspection target sample using the imaging device to acquire an inspection target image, inputting the inspection target image into the multiple non-defective product image estimation model trained, outputting a plurality of estimated non-defective product images corresponding to the inspection target image, and extracting a defective part using the plurality of estimated non-defective product images.

According to the invention, it is possible to provide a defect inspection system and a defect inspection processing method that are capable of obtaining an inspection result with good reproducibility.

Problems, configurations, and effects other than those described above will become apparent from the following description of embodiments.

### BRIEF DESCRIPTION OF THE DRAWINGS

FIG. 1 is a schematic configuration diagram of a defect inspection system according to a first embodiment of the invention;

FIG. 2 is a flowchart illustrating a processing flow of the defect inspection system illustrated in FIG. 1;

FIG. 3 is an example illustrating a structure of a non-defective product image estimation model forming the defect inspection system according to the first embodiment;

FIG. 4 is an example illustrating a structure of a multiple non-defective product image estimation model forming the defect inspection system according to the first embodiment;

FIG. 5 is a flowchart illustrating a training flow of the multiple non-defective product image estimation model by a learning unit illustrated in FIG. 1;

FIG. 6 is a flowchart illustrating a training flow of the non-defective product image estimation model by the learning unit illustrated in FIG. 1;

FIG. 7 is an explanatory diagram of data augmentation processing by the learning unit illustrated in FIG. 1;

FIG. 8 is an explanatory diagram of noise addition processing by the learning unit illustrated in FIG. 1;

FIG. 9 is a flowchart illustrating an inspection processing flow by a defect inspection unit illustrated in FIG. 1;

FIG. 10 is an explanatory diagram of integration of inspection results for defect images by the defect inspection unit illustrated in FIG. 1;

FIG. 11 is an explanatory diagram of false report discrimination processing by the defect inspection unit illustrated in FIG. 1;

FIG. 12A is a diagram illustrating an example of a GUI of a display device illustrated in FIG. 1, illustrating a first half of a display screen;

FIG. 12B is a diagram illustrating an example of the GUI of the display device illustrated in FIG. 1, illustrating a second half of the display screen;

FIG. 13 is an example illustrating a structure of a multi-head model forming a defect inspection system according to a second embodiment of the invention;

FIG. 14 is a flowchart illustrating a training flow of the multi-head model by the learning unit illustrated in FIG. 1;

FIG. 15 is a flowchart illustrating training processing of the multi-head model by the learning unit illustrated in FIG. 1;

FIG. 16 is a flowchart illustrating an inspection flow using a multi-head model forming a defect inspection system according to a third embodiment of the invention;

FIG. 17 is a diagram illustrating an example of inspection of a defect image using integration processing of estimated non-defective product images by the defect inspection unit illustrated in FIG. 1;

FIG. 18 is a diagram illustrating an example of learning of a non-defective product image estimation model using maximization of a non-defective product conversion amount by a learning unit forming a defect inspection system according to a fourth embodiment of the invention;

FIG. 19 is a diagram illustrating an example of inspection processing using selection of an estimated non-defective product image by a defect inspection unit forming a defect inspection system according to a fifth embodiment of the invention; and

FIG. 20 is a diagram illustrating an example of the GUI of the display device illustrated in FIG. 1, illustrating a display screen of the GUI for selecting an estimated non-defective product image.

### DESCRIPTION OF EMBODIMENTS

In this specification, an imaging device includes a charged particle beam device, an optical inspection device, and an imaging device using a camera. Furthermore, the charged particle beam device includes an SEM, a review SEM, an FIB, and the like. The following description uses SEM as an example of the charged particle beam device.

Below, embodiments of the invention are described with reference to the drawings. The embodiments described below do not limit the invention as claimed, and not all of elements and combinations thereof described in the embodiments are necessarily essential to the solution of the invention.

### First Embodiment

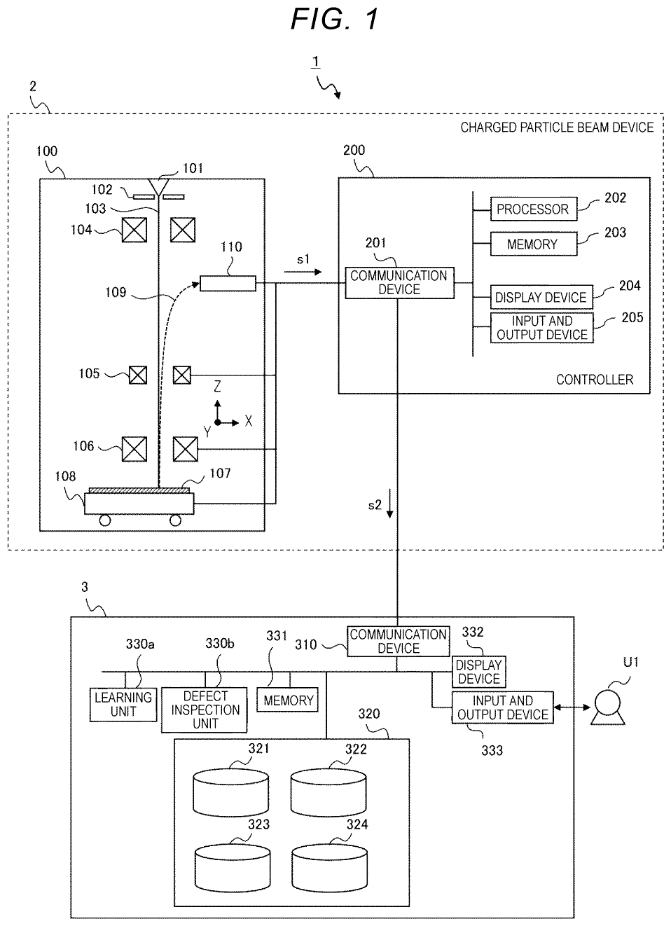

FIG. 1 is a schematic configuration diagram of a defect inspection system according to an embodiment of the invention. As illustrated in FIG. 1, a defect inspection system 1 according to this embodiment includes a charged particle beam device 2 and a computer 3. In this embodiment, an example will be described in which the defect inspection system 1 estimates multiple corresponding non-defective product images from inspection target images of samples captured by the charged particle beam device 2, and extracts defective parts through inspection processing using statistical processing.

### <Configuration of Defect Inspection System>

As illustrated in FIG. 1, the defect inspection system 1 includes the charged particle beam device 2 and the computer 3. The charged particle beam device 2 includes an imaging device 100 and a controller 200. The imaging device 100 includes components such as a stage serving as a sample stage and a driving circuit in a housing, in other words, a column or sample chamber. The controller 200 is a control system that drives and controls the imaging device 100, and can be implemented by a computer or circuit. The computer 3 is, in other words, a computer system. The defect inspection system 1 includes components necessary for generating a signal waveform and an image based on a detection signal from the imaging device 100 that forms the charged particle beam device 2. One example of the charged particle beam device 2 is a Scanning Electron Microscope (SEM).

The imaging device 100 of the charged particle beam device 2 outputs a detection signal s1 obtained based on irradiation of a sample 107 on a stage 108 with a charged particle beam 103. The controller 200 inputs or receives the detection signal s1, processes it, and generates and stores a signal such as an image as a detection signal of the charged particle beam device 2. The controller 200 outputs a signal s2 of the image or the like. The computer (computer system) 3 inputs or receives the signal s2 of the image or the like and processes it.

In the imaging device 100 of the charged particle beam device 2, the charged particle beam 103 extracted from an electron source 101 by an extraction electrode 102 is accelerated by an acceleration electrode (not illustrated). The accelerated charged particle beam 103 is focused by a condenser lens 104, which is a form of a focusing lens. The charged particle beam 103 is deflected by a scanning deflector 105 to scan one-dimensionally or two-dimensionally on a surface of the sample 107 on the stage 108, which is a sample stage. The charged particle beam 103 is decelerated by a negative voltage (retarding voltage) applied to an electrode built into the stage 108, which is a sample stage, and is focused by a lens action of an objective lens 106 and irradiated onto the sample 107. The stage 108 may be a mechanism capable of moving in a Z direction corresponding to a vertical direction and perpendicular to X and Y directions, or may be a mechanism capable of rotating and tilting in each axial direction. In addition, although there are no limitations on details of the implementation of the charged particle beam device 2, a configuration that emits multiple beams may be used. In addition, although the charged particle beam device 2 is illustrated as having one detector 110, the invention is not limited to this and may be configured to have a plurality of detectors. For example, a configuration that includes an SE detector that detects Secondary Electron (SE) and a BSE detector that detects Backscattered Electron (BSE) may be used. In addition, for example, a configuration in which a plurality of detectors are respectively installed at a plurality of positions may be used. In other words, as a configuration for capturing an image, a configuration may be used that includes a plurality of channels and a plurality of detection systems. In addition, when generating an image, a single image may be generated by accumulating a plurality of images based on a plurality of signals repeatedly detected from the same area.

The sample 107 is, for example, a semiconductor wafer. When the sample 107 is irradiated with the charged particle beam 103, electrons 109 such as secondary electrons (SE) and backscattered electrons (BSE) are emitted from inside the sample 107. The emitted electrons 109 are accelerated by an acceleration action based on a negative voltage (retarding voltage) applied to the sample 107, and are captured by the detector 110. The detection signal s1 output from the detector 110 is sent to the controller 200. The controller 200 receives the detection signal s1 via a communication device 201.

The controller 200 includes the communication device 201, a processor 202, a memory 203 such as a RAM or a non-volatile storage device, a display device 204, and an input and output device 205. These components are connected to each other by an architecture such as a bus. The controller 200 controls the imaging by the imaging device 100 according to a set imaging recipe. The processor 202 generates an observation image (inspection target image) based on the detection signal s1 obtained via the communication device 201 as an image of which the brightness is determined by an amount of electrons captured by the detector 110. The processor 202 stores data such as the generated observation image (inspection target image) in the memory 203. The processor 202 transmits a signal s2 corresponding to data such as the generated observation image (inspection target image) to the computer 3 via the communication device 201. The computer 3 receives the signal s2 via a communication device 310. A user U1 may use the controller 200 by operating the display device 204 and the input and output device 205.

The communication device 201 is a device that implements a communication interface with the imaging device 100 and a communication interface with the computer 3. The communication interface may be, for example, a LAN, but is not limited to this. The input and output device 205 is an input device and an output device. The input device and the output device may be built-in or may be externally connected. Examples of the input device include a keyboard, a mouse, or a microphone. Examples of the output device include a display, a printer, or a speaker.

The computer 3 includes the communication device 310, a storage 320, a learning unit 330a, a defect inspection unit 330b, a memory 331 such as a RAM or a non-volatile storage device, a display device 332, and an input and output device 333. These components are connected to each other by an architecture such as a bus. The storage 320 is a memory with a relatively large storage area. The storage 320 stores a learning image DB 321, an inspection target image DB 322, a learned parameter DB 323, and a program 324. The memory 331 of the computer 3 also stores other necessary management information and a database (DB). An external storage device or a server may be connected to the computer 3, and necessary data and information may be stored in the external storage device or the server, and the data and information may be read and written as appropriate. The learning unit 330a and the defect inspection unit 330b are realized by, for example, a processor such as a CPU (not illustrated), a ROM for storing various programs, a RAM for temporarily storing data in a calculation process, and a storage device such as an external storage device, and the processor such as a CPU reads and executes the various programs stored in the ROM, and stores calculation results, which are execution results, in the RAM, the external storage device, or in a cloud storage via a network connection. Alternatively, the various programs may be stored in the program 324 in the storage 320. The memory 331 may also be configured to appropriately store various data and information processed by the learning unit 330a and the defect inspection unit 330b. The memory 331 stores, for example, program execution modules, image data, and processing result information. The storage 320 may store processing result information, history information, screen data, and the like in addition to the DB illustrated in the figure.

The communication device 310 is a device that implements a communication interface with the controller 200. External devices may be connected to the computer (computer system) 3 via a network such as a LAN. The input and output device 333 is an input device and an output device. The input device and the output device may be built-in or may be externally connected. Examples of the input device include a keyboard, a mouse, or a microphone. Examples of the output device include a display, a printer, or a speaker.

The user U1 of the defect inspection system 1 operates the display device 332 and the input and output device 333 to use the computer (computer system) 3. In this way, the user U1 uses the defect inspection system 1. A display screen of the display device 332 displays a screen that serves as the user interface of the defect inspection system 1, in other words, a screen with a graphical user interface (GUI). The computer 3 may be configured as a client-server system. In that case, the user U1 operates a PC or the like that serves as a client terminal, and accesses the computer (computer system) 3 that serves as a server via communication with the PC or the like.

The computer (computer system) 3 is a part that executes processing characteristic of this embodiment. The computer (computer system) 3 is connected to the controller 200. The controller 200 may be configured as part of the computer (computer system) 3, and the computer 3 may be configured as part of the controller 200. The controller 200 and the computer (computer system) 3 may be configured as an integrated computer system. The controller 200 may be configured to execute at least a part of the processing characteristic of this embodiment. The entire system including the computer (computer system) 3 may be considered as the charged particle beam device 2.

In addition, when the computer 3 (computer system) is in the form of a client-server system, the operation is as follows, for example. The user U1 accesses the computer (computer system) 3 as a server from a client terminal such as a PC via a network. The server provides a screen with a graphical user interface (GUI) to the client terminal. The server transmits GUI screen data (for example, a web page) for this purpose to the client terminal. The client terminal displays a GUI screen on a display based on the received screen data. The user U1 looks at the GUI screen and inputs instructions and settings. The client terminal transmits the input information to the server. The server executes processing according to the received input information. For example, the server evaluates the captured image and estimates the device status, stores the processing results, and transmits GUI screen data (or only update information) for displaying the processing results to the client terminal. The client terminal updates the display of the GUI screen based on the received screen data. The user U1 can check the processing results, such as the estimation result of the device status, by looking at the GUI screen.

### <Processing Flow of Defect Inspection System>

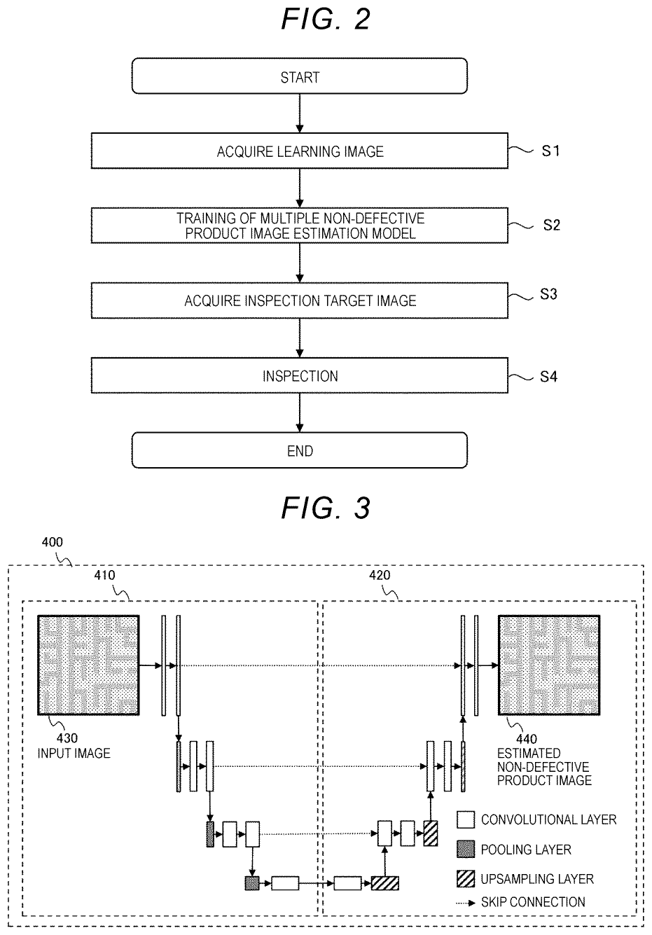

FIG. 2 is a flowchart illustrating a processing flow of the defect inspection system 1 illustrated in FIG. 1. As illustrated in FIG. 2, in step S1, an electron beam (charged particle beam) 103 is scanned over an observation area of the sample 107, and the detection signal s1 captured by the detector 110 is sent to the controller 200 via the communication device 201. The observation image generated by the processor 202 based on the sent detection signal s1 is sent to the computer (computer system) 3 via the communication device 301. The learning unit 330a stores the sent observation image in the learning image DB 321.

In step S2, the learning unit 330a determines internal parameters of a multiple non-defective product image estimation model that generates a plurality of non-defective product images corresponding to the input image by learning using the learning image DB 321, and stores the determined internal parameters in the learned parameter DB 323.

In step S3, the electron beam (charged particle beam) 103 is scanned over an area on the sample 107 to be inspected for defects, and the detection signal s1 captured by the detector 110 is sent to the controller 200 via the communication device 201. The observation image generated by the processor 202 based on the sent detection signal s1, is sent to the computer 300 via the communication device 310. The defect inspection unit 330b stores the signal s2 corresponding to the data such as the sent observation image (inspection target image) in the inspection target image DB 322.

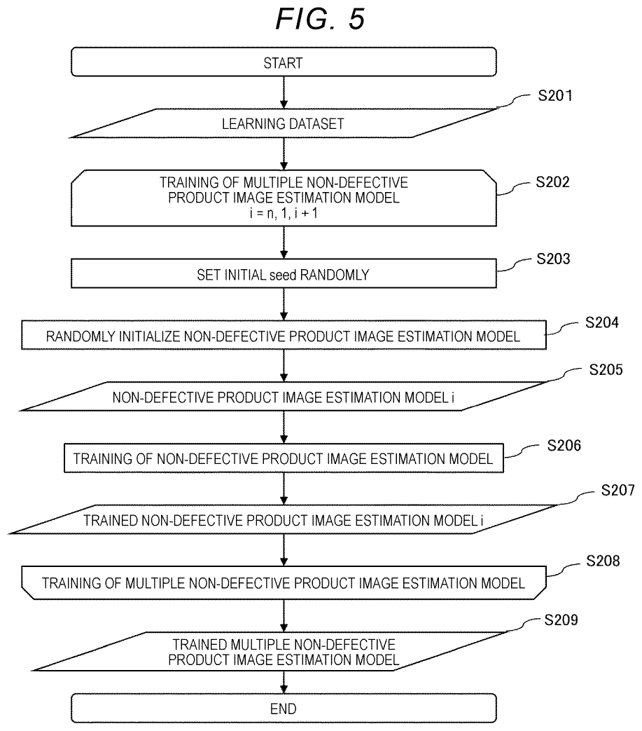

In step S4, the defect inspection unit 330b inputs, as input images, images to be inspected among the images stored in the inspection target image DB 322 into a multiple non-defective product image estimation model 401 (described below in FIG. 4) of which the internal parameters are read from the learned parameter DB 323, and outputs the plurality of non-defective product images corresponding to the input images. The inspection results are output using the input image and the plurality of output non-defective product images, and the process ends.

<Example of Inspection using Multiple Non-defective Product Image Estimation Model>

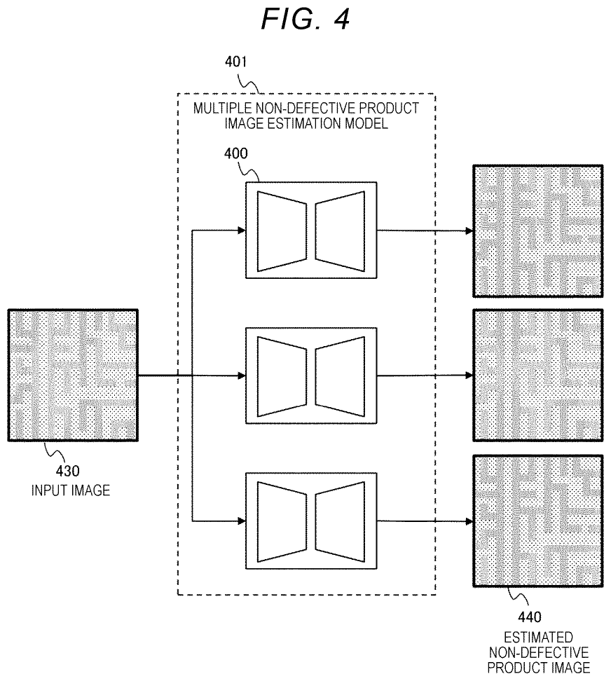

Referring to FIGS. 3 to 12A and 12B, a specific example of defect inspection processing will be described below assuming a case where defects on a semiconductor wafer, which is the sample 107, are inspected by the defect inspection system 1 according to this embodiment.

FIG. 3 is an example illustrating a structure of a non-defective product image estimation model forming the defect inspection system 1 according to the present embodiment. As illustrated in FIG. 3, a non-defective product image estimation model 400 is configured based on a machine learning model, such as an Auto Encoder, U-Net, or Generative Adversarial Networks (GAN). When an amount of defect images used for model training is insufficient, such as in early stages of operation of the defect inspection system 1, these models are trained to estimate a non-defective product image corresponding to an input image 430 using only non-defective product images as learning data, thereby enabling defect inspection by comparing the input image 430 with the estimated non-defective product image (estimated non-defective product image 440). As an example of a learning method, the internal parameters are repeatedly updated so that an error between the input image 430 to the model and the output image is minimized, and the model learns to represent features of non-defective product images and reconstruct non-defective product images from a subspace constructed by the feature representation.

In this embodiment, the non-defective product image estimation model 400 based on U-net will be described as an example. U-net is composed of a feature extraction unit 410 in a first half and an image generation unit 420 in a second half. The feature extraction unit 410 has a structure in which processing is repeated using a convolutional layer that extracts image features and a pooling layer that reduces the size of an output vector of the convolutional layer, and thus obtains local and global feature amounts of the input image 430. In the image generation unit 420 in the second half, the feature amounts obtained by the feature extraction unit 410 in the first half are repeatedly processed using the convolutional layer and an upsampling layer that increases the size of the output vector of the convolutional layer, thereby obtaining an estimated non-defective product image 440 of the same size as the input image 430. In addition, a skip connection is used to connect the output of the feature extraction unit 410 to the feature amount obtained by upsampling, and thus a clearer output image can be obtained. This non-defective product image estimation model 400 is trained using non-defective product images as learning data, and internal parameters that can represent the features of non-defective product images and generate non-defective product images from the extracted feature amount are learned.

FIG. 4 illustrates an example of a structure of the multiple non-defective product image estimation model 401 forming the defect inspection system according to this embodiment. The multiple non-defective product image estimation model 401 is composed of a plurality of non-defective product image estimation models 400, and by inputting one input image 430, the same number of estimated non-defective product images 440 as the number of non-defective product image estimation models 400 that are composed are output. Each non-defective product image estimation model 400 has the same structure, but has different internal parameters determined by a training processing including randomness, so that it outputs different estimated non-defective product images 440 for the same input image. It is sufficient that the multiple non-defective product image estimation model 401 is composed of at least two or more non-defective product image estimation models 400.

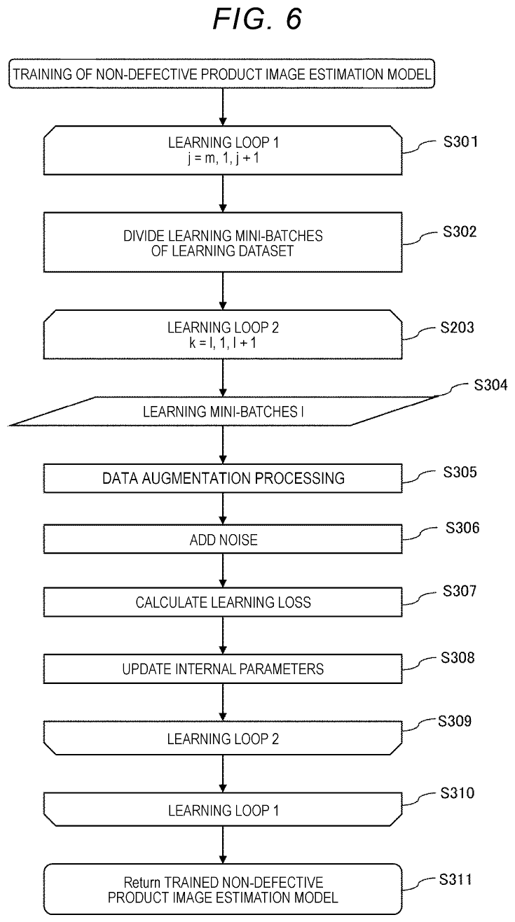

FIG. 5 is a flowchart illustrating a training flow of the multiple non-defective product image estimation model 401 by the learning unit 330a illustrated in FIG. 1. An example of learning the multiple non-defective product image estimation model 401 including n non-defective product image estimation models 400 will be described. First, in step S201, the learning unit 330a reads images used for learning the multiple non-defective product image estimation model 401 from the learning image DB 321 and creates a learning dataset.

Then, in step S202, the learning unit 330a learns a plurality of (i=n, 1, i+1) non-defective product image estimation models 400 to generate the multiple non-defective product image estimation models 401. Before starting the learning of each non-defective product image estimation model 400, a random initial seed is set for each non-defective product image estimation model 400 so that there is no overlap (step S203). As an example of a method for determining the initial seed, it can be determined based on the call time of a function that sets the initial seed of the program. Next, in step S204, the learning unit 330a sets initial values of the internal parameters of the non-defective product image estimation model 400(i). Since the initial values are determined by referring to a random number table, different values are set when the initial seeds are different (step S205).

Next, in step S206, the learning unit 330a performs training processing to determine internal parameters of the non-defective product image estimation model 400(i) with the initial values set using the learning dataset, thereby creating a trained non-defective product image estimation model 400(i) (step S207). The process from setting of the initial seed to the training processing is repeated at least twice (step S208), thereby creating a trained multiple non-defective product image estimation model 401 (step S209). After creating an arbitrary number of trained multiple non-defective product image estimation models 401, all internal parameters are treated as internal parameters of one multiple non-defective product image estimation model 401 and stored in the learned parameter DB 323.

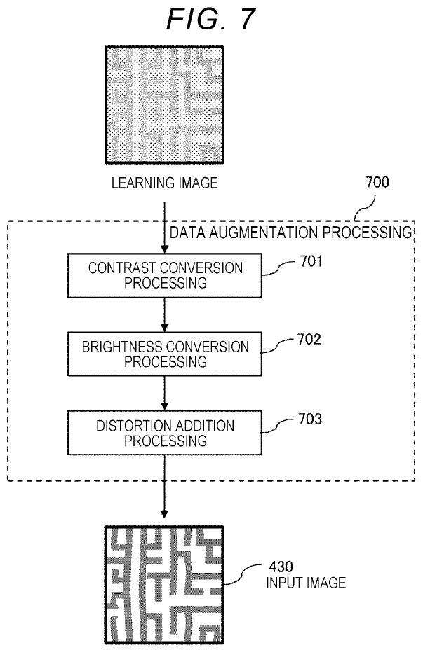

FIG. 6 is a flowchart illustrating a training flow of the non-defective product image estimation model by the learning unit illustrated in FIG. 1. As illustrated in FIG. 6, in step S301, a learning loop 1 is started (i=n, 1, i+1). First, in step S302, the learning unit 330a performs learning mini-batch division of the learning dataset. In the learning mini-batch division, the images included in the learning dataset are divided into an arbitrary number of images, and each is set as a learning mini-batch. For each divided learning mini-batch, data augmentation (step S305), noise addition (step S306), learning loss calculation (step S307), and internal parameter updating (step S308) are performed. In the data augmentation processing (step S305), the learning unit 330a performs brightness conversion, contrast conversion, and distortion addition on each image included in the learning mini-batch, each with a random intensity within a certain range based on a reference value in a random number table, to create an input image for the non-defective product image estimation model 400. To allow the non-defective product image estimation model 400 to learn the estimation processing from a defective product image to a non-defective product image, noise is added to the input image as a defective product feature to create a defective product image. The created defective product image is input to the non-defective product image estimation model 400 to obtain the estimated non-defective product image 440 as an output. In this case, an average squared error of the brightness of each pixel of the estimated non-defective product image and the input image 430, which is the image before noise is added, is calculated as the learning loss. The learning loss may include Structural Similarity (SSIM), which is an index value related to image quality, and a regularization term that penalizes internal parameters to prevent overfitting to the learning dataset. Based on the calculated learning loss, the values of the internal parameters that reduce the learning loss are searched for using an optimization method such as gradient descent, and the internal parameters of the non-defective product image estimation model 400 are updated based on the search results. The process from the data augmentation processing (step S305) to the internal parameter updating (step S308) is repeated the same number of times as the number of learning mini-batches, and then the learning dataset is divided into learning mini-batches again and the internal parameters are updated for each learning mini-batch. The internal parameters of the non-defective product image estimation model are determined by repeating this learning loop an arbitrary number of times.

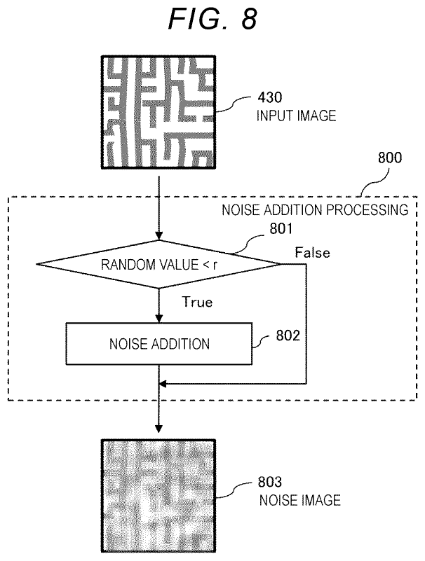

FIG. 7 is an explanatory diagram of the data augmentation processing by the learning unit 330a illustrated in FIG. 1. As illustrated in FIG. 7, in data augmentation processing 700, the learning unit 330a processes contrast conversion 701, brightness conversion 702, and distortion addition 703 for each learning image included in the learning mini-batch. As a result, the input image 430 is created. In the contrast conversion 701, the contrast of the entire image to be processed is randomly changed within a set range. For example, the contrast can be changed randomly by updating the value with a brightness value of each pixel multiplied by a random value selected from the range of 0.8 to 1.2. When the value is less than 1.0, the contrast is lowered, and when the value is greater than 1.0, the contrast is increased. In the brightness conversion 702, a randomly determined brightness value is added to each pixel of the image, or a random value is determined for each pixel and added to the brightness value. The value to be added is a value randomly selected from a set range. The range is, for example, ±10% of an average value of pixel values of the entire image to be processed. In the distortion addition 703, the image to be processed is randomly distorted using transformation processing. An image can be distorted, for example, by applying an affine transformation to vertical and horizontal directions of the image. By learning that images in which the brightness change, contrast, and image distortion have changed within a certain range are considered to be non-defective products, it is possible to improve robustness of the inspection processing against distortion caused by the imaging device 100 and changes in image quality such as brightness and contrast due to changes in a state of the imaging device 100 during operation.

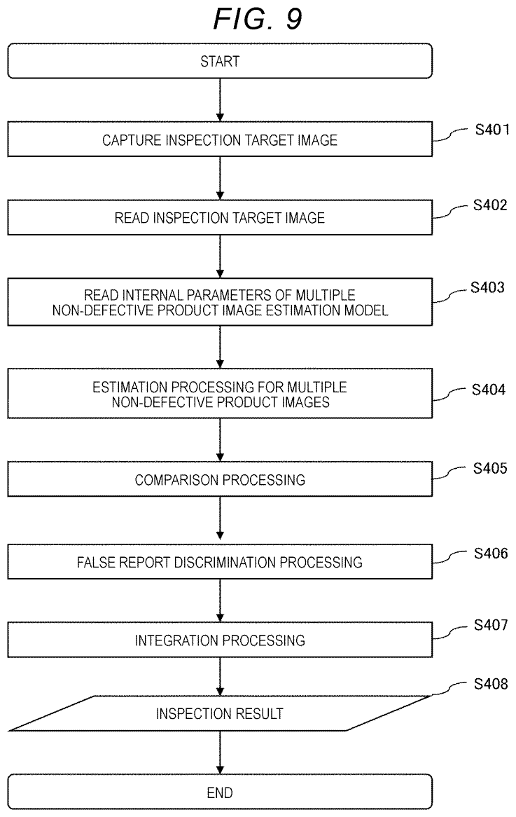

FIG. 8 is an explanatory diagram of noise addition processing 800 by the learning unit 330a illustrated in FIG. 1. In the noise addition processing 800, the learning unit 330a adds noise as an image feature that is not good to the input image 430 created by the data augmentation processing. The noise addition processing 800 is performed probabilistically using random numbers. For example, a random value is obtained from a range of 0 to 1 as the random number value, and the noise addition processing (802) is performed only when the random number value is smaller than a set value (801). When the set value is 0.8, the noise addition processing 802 is performed with a probability of 80%. By performing the noise addition processing 800 probabilistically, the learning mini-batch includes images with no noise added and images with noise added, and it is possible to learn to leave non-defective product images as the non-defective product images and convert defective product images to non-defective product images. A method of generating noise to be added as an image feature that is not good is, for example, Perlin noise and wavelet noise. Both noise generation methods can generate images with random patterns, and the generated image is multiplied by a random coefficient within a certain range and the resultant value is added to the non-defective product image to create a noise image 803 having defective product features. In addition to the above-described noise generation methods, as defective product features, an image obtained by cutting out a part of the image or another image in the learning dataset may be pasted onto the input image 430, or lines of random position, angle, length, thickness, and brightness may be drawn.

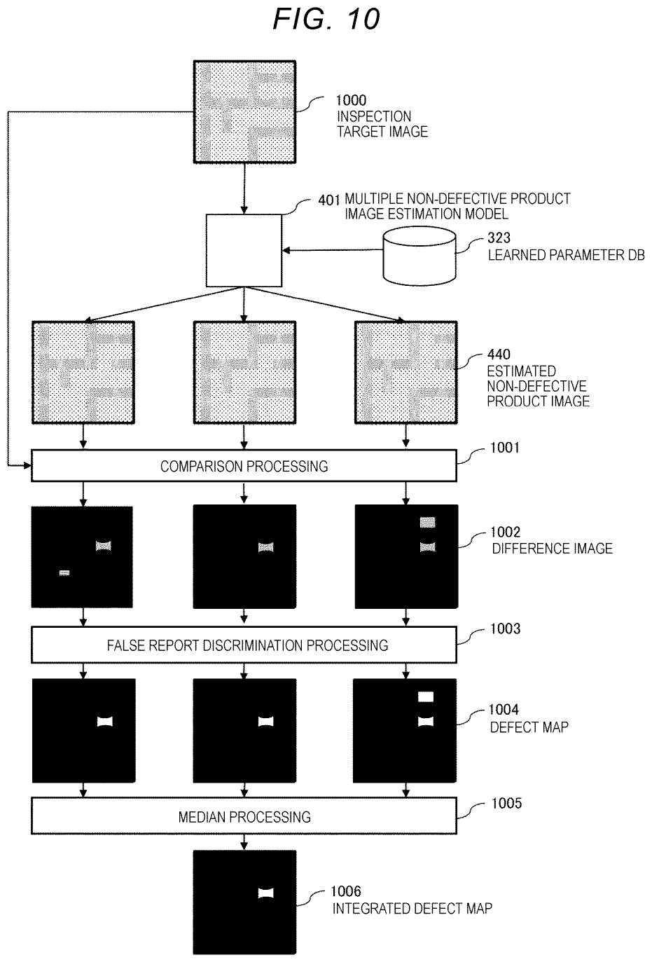

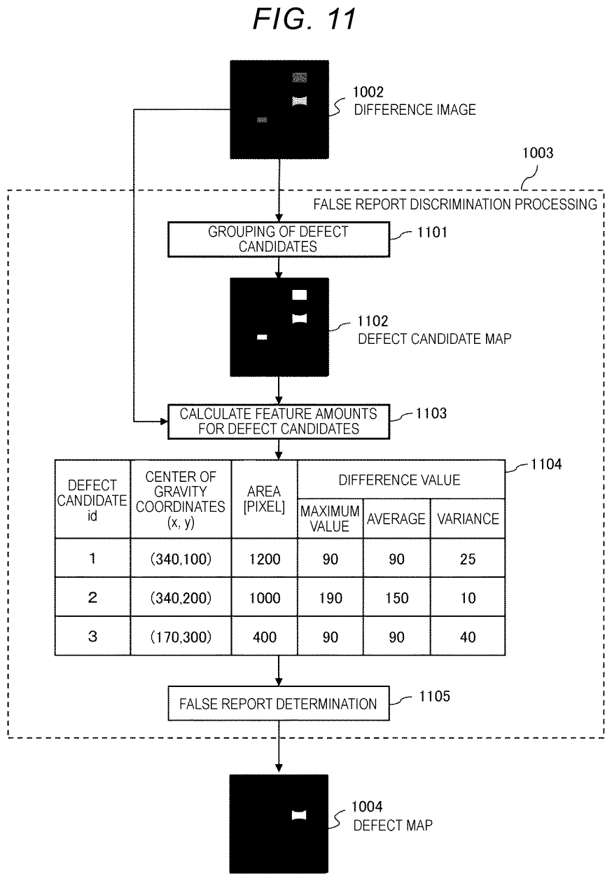

FIG. 9 is a flowchart illustrating an inspection processing flow by the defect inspection unit 330b illustrated in FIG. 1. As illustrated in FIG. 9, first, in step S401, an inspection area of the sample 107 to be inspected is scanned with the charged particle beam 103, and the acquired inspection target image is stored in the inspection target image DB 322. Next, in step S402, the defect inspection unit 330b reads the image to be inspected from the inspection target image DB 322. Next, in step S403, the defect inspection unit 330b reads the internal parameters of the multiple non-defective product image estimation model 401 from the learned parameter DB 323. In step S404, the defect inspection unit 330b inputs an inspection target image 1000 (FIG. 10) to the multiple non-defective product image estimation model 401 with the internal parameters read, and outputs a plurality of estimated non-defective product images 440 (FIG. 10). When the inspection target image 1000 containing defects is input to the multiple non-defective product image estimation model 401, an image in which the defective parts are converted to look good is output. Therefore, in comparison processing (step S405), the defect inspection unit 330b compares the inspection target image 1000 with each of the estimated non-defective product images 440 to extract the defective parts, and creates difference images in which each pixel shows a difference in pixel values between the inspection target image 1000 and the estimated non-defective product image 440. In this case, in order to output a plurality of estimated non-defective product images 440 for one inspection target image 1000, the same number of difference images 1002 (FIG. 10) as the estimated non-defective product images 440 are created. In false report discrimination processing (step S406), the defect inspection unit 330b eliminates false reports, which are parts where differences have occurred but are not actually defective, based on the image features of the difference images 1002, and outputs a defect map 1004 (FIG. 10) showing the defective parts. The number of output defect maps 1004 is the same as the estimated non-defective product images 440. In integration processing (step S407), the defect inspection unit 330b performs statistical processing on a plurality of defect maps 1004, and outputs one integrated defect map 1006 (FIG. 10) as the inspection result (step S408).

FIG. 10 is an explanatory diagram of the integration of inspection results for defective images by the defect inspection unit 330b illustrated in FIG. 1. As illustrated in FIG. 10, the multiple non-defective product image estimation model 401 includes three non-defective product image estimation models (not illustrated), and an example will be described in which three estimated non-defective product images 440 are output for one inspection target image 1000. The inspection target image 1000 is an example of an image that shows a semiconductor circuit pattern using the charged particle beam device 2. The defect inspection unit 330b inputs the inspection target image 1000 to the multiple non-defective product image estimation model 401 of which internal parameters are read from the learned parameter DB 323, thereby obtaining three estimated non-defective product images 440. The three non-defective product image estimation models 400 (not illustrated) have different internal parameters, so they output different estimated non-defective product images 440 even when the same inspection target image 1000 is input. Next, the difference images 1002 are created by comparing each of the three estimated non-defective product images 440 with the inspection target image 1000. The area where a difference occurs in the comparison processing 1001 is an area where the inspection target image 1000 has been converted into a different shape, and is therefore likely to be a defect. Next, false report discrimination processing 1003 is performed on the difference image 1002 to exclude the area where a difference occurs but is not actually defective, and the defect map 1004 showing the defective part is created. Next, the integrated defect map 1006 showing a median value of the pixel values at the same position on the three defect maps 1004 is created as the statistical processing for the three defect maps 1004. By using the median value of the plurality of defect maps 1004 (median processing 1005), it is possible to eliminate false reports that occur when the multiple non-defective product image estimation model 401 includes non-defective product image estimation model 400 with a large estimation error for a specific non-defective product pattern due to the randomness of learning. In addition, by using the defective parts extracted from the plurality of defect maps 1004 as final inspection results, it is possible to suppress inspection variations such as extraction being possible in one model but not in another model, and improve reproducibility of the inspection results. The statistical processing when integrating the defect maps 1004 may be the average value, the most frequent value, or the maximum value.

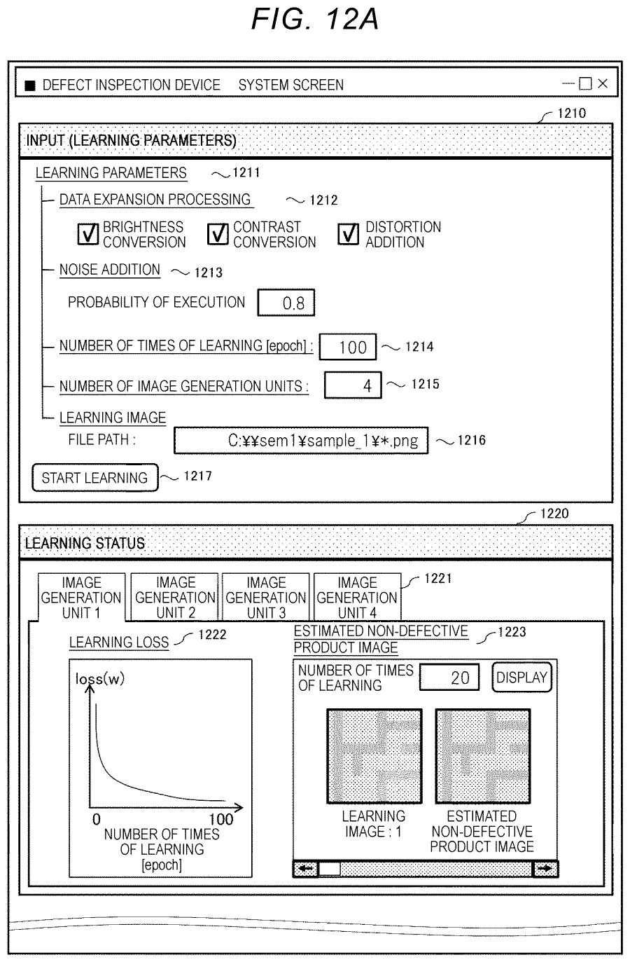

FIG. 11 is an explanatory diagram of the false report discrimination processing by the defect inspection unit 330b illustrated in FIG. 1. The target of the false report discrimination processing is the difference image 1002 (FIG. 10) created by the comparison processing 1001 (FIG. 10) of the inspection target image 1000 (FIG. 10) and the estimated non-defective product image 440 (FIG. 10). As illustrated in FIG. 11, first, the defect inspection unit 330b performs defect candidate grouping processing 1101 on the difference image. In the grouping processing 1101, a defect candidate map 1102 in which an area with a pixel value equal to or greater than a certain value is set to 1 and the other areas are set to 0 is created because a defective part has a high pixel value locally in the difference image 1002. Then, using labeling processing of assigning the same classification number to pixels to be connected, the connected areas are treated as one defect candidate and a corresponding defect candidate id is given. Next, the defect inspection unit 330b calculates 1103 a feature amount of each defect candidate using the difference image 1002 and the defect candidate map 1102. The feature amount is, for example, the coordinates of the center of gravity, the area on the defect candidate map 1102, and the maximum value, average, and variance of the brightness difference value. The feature amount of the defect candidate may be, for example, a minimum value, circularity, edge strength, and the like. Next, the defect inspection unit 330b determines whether each defect candidate is a false report or a real report by false report determination processing 1105. Conditions for determining a defect candidate as a false report are that, for example, the area is equal to or less than a threshold, the maximum value of the brightness difference value is equal to or less than a threshold, the average value of brightness difference is equal to or less than a threshold, and the variance of the brightness difference is equal to or less than a certain value. Here, the variance and the maximum value of the brightness value are values for each pixel, and the average is the average value of all pixel brightness values in a region. A combination of a plurality of conditions may also be used. An image in which the pixel value of the defect candidate on the defect candidate map corresponding to a defect candidate id determined to be a false report is changed to 0 is output as the defect map 1004.

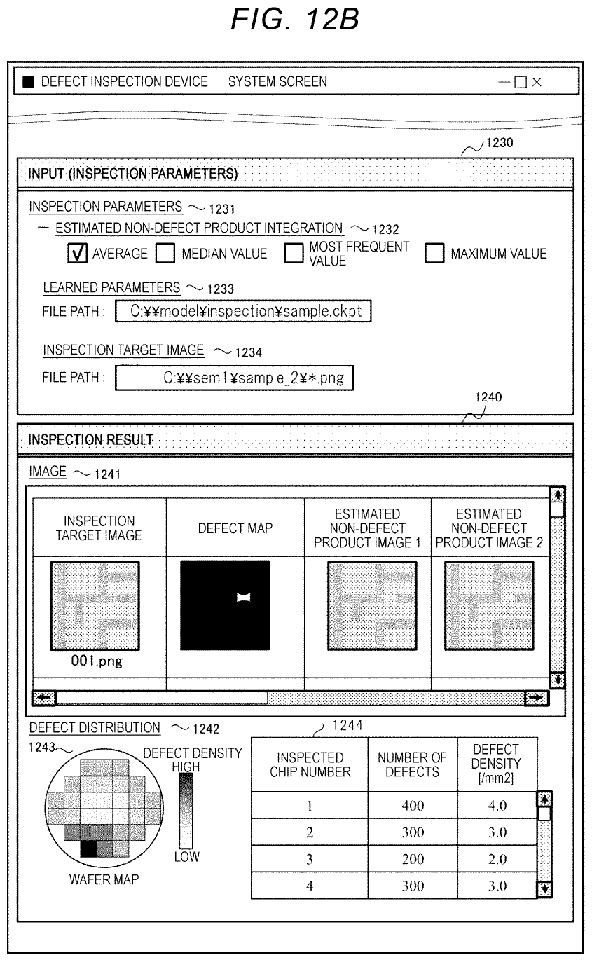

FIG. 12A is a diagram illustrating an example of a GUI of a display device illustrated in FIG. 1, illustrating a first half of a display screen, and FIG. 12B is a diagram illustrating an example of the GUI of the display device illustrated in FIG. 1, illustrating a second half of the display screen. As illustrated in FIG. 12A, the GUI according to this embodiment has an input field 1210 for learning parameters of the multiple non-defective product image estimation model 401 and a display field 1220 for a learning status. The input field 1210 for learning parameters includes input fields for parameters related to data augmentation processing 1212, noise addition 1213, the number of times of learning 1214, the number of image generation unit 1215, and a learning image 1216 as learning parameters 1211. In the input field for data augmentation processing 1212, a check box is used to select the expansion processing to be executed during learning. In the input field for the noise addition 1213, a value from 0.0 to 1.0 is input as the probability of executing noise addition during learning. In the input field for the number of image generation units 1215, the number of estimated non-defective product images that the multiple non-defective product image estimation model 401 outputs for one input image is input. Depending on the number of image generation units 1215, it is determined how many non-defective product image estimation models 400 the multiple non-defective product image estimation model 401 should be composed of. In the input field for the learning image 1216, a file path of the image used for training the multiple non-defective product image estimation model 401 is input. During learning, the image corresponding to the specified file path is used. After inputting each parameter, a learning start button 1217 is pressed (clicked with a mouse or the like) to start training the multiple non-defective product image estimation model 401. The display field 1220 for the learning status has display fields where a display field 1222 for a learning loss of the multiple non-defective product image estimation model 401 and a display field 1223 for the estimated non-defective product image can be checked for each image generation unit 1221. The display field 1222 for the learning loss displays the learning loss for each of the number of times of learning of the internal parameters of the multiple non-defective product image estimation model 401. The display field 1223 for estimated non-defective product image has an input field for the number of times of learning. After inputting an arbitrary number of times of learning in the input field for the number of times of learning, the display button (clicked with a mouse or the like) is pressed to display the learning image and the corresponding estimated non-defective product image 440 for the corresponding number of times of learning of the internal parameters of the multiple non-defective product image estimation model 401.

As illustrated in FIG. 12B, the GUI according to this embodiment has an input field 1230 for the inspection parameters of the multiple non-defective product image estimation model 401 and a display field 1240 for the inspection results. The input field 1230 for the inspection parameters includes an input field 1232 for the estimated non-defective product integration, an input field 1233 for the learned parameters of the multiple non-defective product image estimation model 401, and an input field 1234 for the inspection target image. In the input field 1232 for the estimated non-defective product integration, a check box is used to select a statistical processing method to be used in integration processing. In the input field 1233 for the learned parameters, the path of the file in which the internal parameters of the multiple non-defective product image estimation model 401 are stored is input. In the input field 1234 for the inspection target image, the file path of the inspection target image to be inspected is input. The display field 1240 for the inspection results includes a display field 1241 for an image and a display field 1242 for a defect distribution. The display field 1241 for the image displays an inspection target image, defect map, and each estimated non-defective product image as the inspection target. The display field 1242 for the defect distribution displays a wafer map 1243 showing a defect density for each area on the semiconductor wafer, which is the sample 107, and the number of defects and defect density (color bar display) in each area. The areas are, for example, semiconductor chips manufactured on the semiconductor wafer.

As described above, according to this embodiment, it is possible to provide a defect inspection system and a defect inspection processing method that are capable of obtaining an inspection result with good reproducibility.

### Second Embodiment

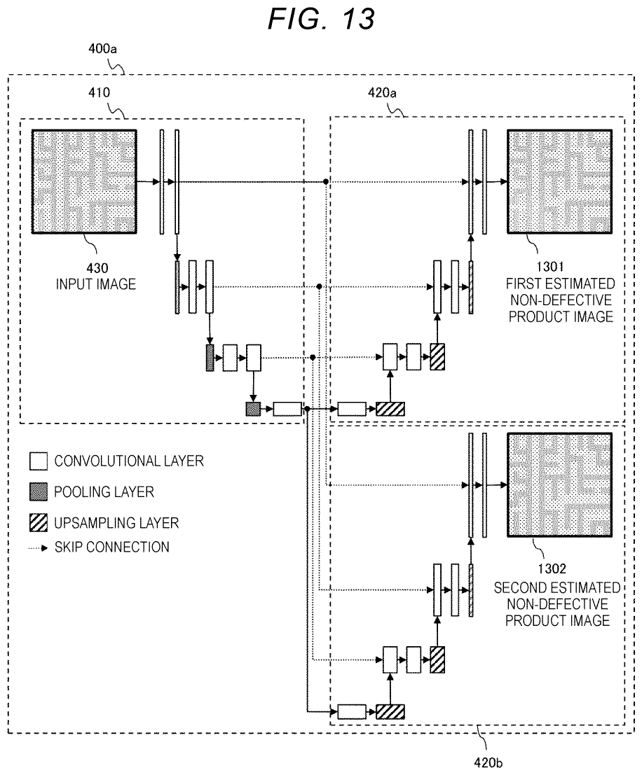

A second embodiment will be described with reference to FIGS. 13 to 15. A basic configuration of the second embodiment is similar to and common to that of the first embodiment, and the following mainly describes configuration parts of the second embodiment that are different from the first embodiment. In this embodiment, the multiple non-defective product image estimation model 401 is not composed of a plurality of non-defective product image estimation models, but is composed of a common feature extraction unit 410 and a plurality of image generation units. A specific example will be described below.

FIG. 13 is an example illustrating a structure of a multi-head model forming a defect inspection system according to the second embodiment. As illustrated in FIG. 13, the multi-head model is an example of a non-defective product image estimation model 400a, and is composed of a feature extraction unit 410 in a first half and a plurality of image generation units in a second half. The plurality of image generation units in the second half specifically include a first image generation unit 420a and a second image generation unit 420b. The feature extraction unit 410 has a structure that repeats processing using a convolutional layer that extracts image features and a pooling layer that reduces the size of an output vector of the convolutional layer, and inputs the extracted feature amount to each of the image generation units (the first image generation unit 420a and the second image generation unit 420b) in the second half. The first image generation unit 420a and the second image generation unit 420b obtain an output of the same size as the input image by repeating processing of the feature amount obtained from the feature extraction unit 410 using the convolutional layer and an upsampling layer that increases the size of an output vector of the convolutional layer. With this model structure, when one input image 430 is input to the multi-head model, the same number of estimated non-defective product images as the number of image generation units are output. Specifically, the first image generation unit 420a outputs a first estimated non-defective product image 1301, and the second image generation unit 420b outputs a second estimated non-defective product image 1302. In this way, the input image multi-head model is composed of at least two or more image generation units.

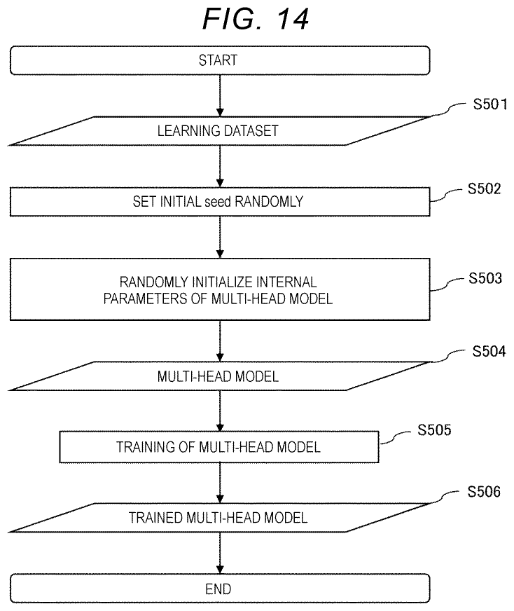

FIG. 14 is a flowchart illustrating a training flow of a multi-head model by the learning unit illustrated in FIG. 1. The following describes an example of training a multi-head model including n image generation units. As illustrated in FIG. 14, the learning unit 330a first reads images to be used for training the multi-head model from the learning image DB 321 and creates a learning dataset (step S501). The learning unit 330a then randomly sets an initial seed (step S502). In step S503, the learning unit 330a randomly initializes the internal parameters of the multi-head model. The learning unit 330a stores all internal parameters of the trained multi-head model obtained by executing the training processing of the initialized multi-head model (steps S504 and S505) in the learned parameter DB 323 (step S506) and ends the process.

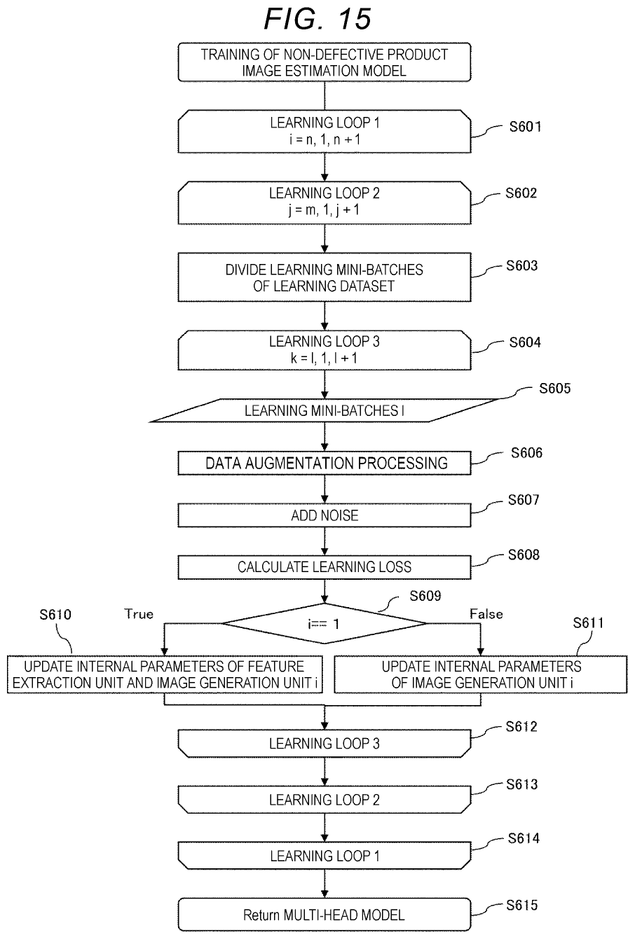

FIG. 15 is a flowchart illustrating training processing of the multi-head model by the learning unit 330a illustrated in FIG. 1. First, the learning unit 330a divides the learning dataset into learning mini-batches (step S603). For each divided learning mini-batch, data augmentation (step S606), noise addition (step S607), and learning loss calculation (step S608) are performed. When i in a learning loop 1 in the flowchart of FIG. 15 is 1, that is, when the process corresponds to a first iteration of the learning loop 1 (step S609), the internal parameters of the feature extraction unit 410, the first image generation unit 420a, and the second image generation unit 420b are updated. When i is other than 1 (step S609), the internal parameters of the first image generation unit 420a and the second image generation unit 420b are updated. In a learning loop 3, the internal parameters are updated using one entire learning mini-batch, and then the learning dataset is divided into learning mini-batches again, and the learning loop 3 is executed (steps S604 and S612). In a learning loop 2, the learning loop 3 is executed m times (steps S602 and S613). m can be any number equal to or greater than 1. In the learning loop 1, the learning loop 2 is executed the same number of times as n, which is the number of image generation units (steps S601 and S614).

As described above, according to this embodiment, in addition to the effects of the first embodiment, the multi-head model has a plurality of image generation units for a common image feature extraction unit, which reduces the number of model parameters and reduces the processing time and resource consumption for learning and inspection.

### Third Embodiment

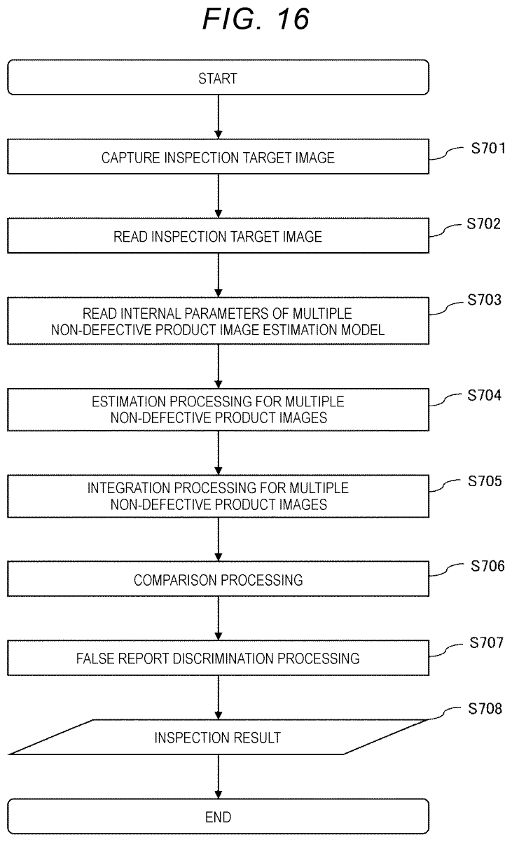

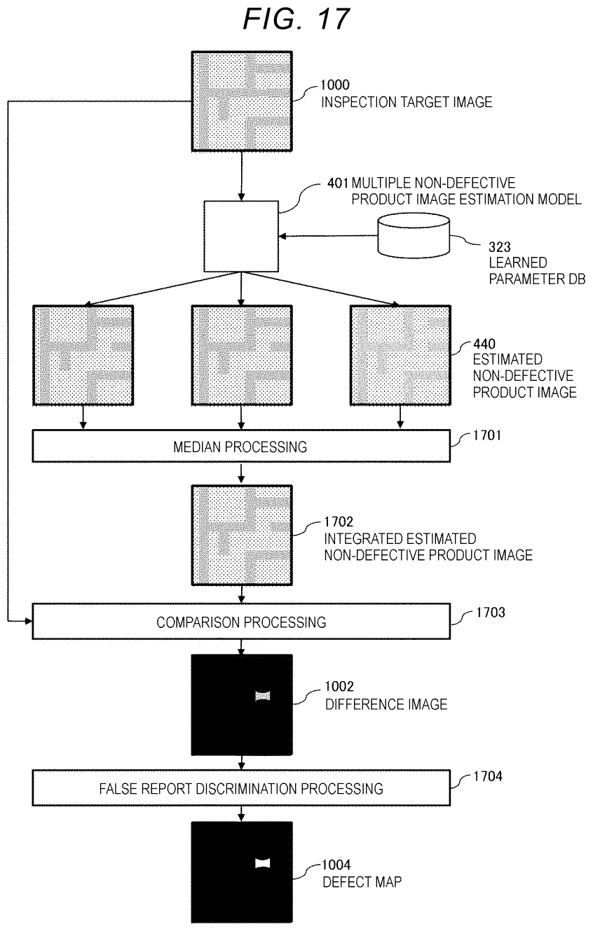

A third embodiment will be described with reference to FIGS. 16 and 17. A basic configuration of the third embodiment is similar to and common to that of the first embodiment, and the following mainly describes the configuration parts of the third embodiment that are different from the first embodiment. In the third embodiment, in an inspection flow, integration processing is not performed on a defect map, but on an estimated non-defective product image, to extract defective parts. A specific example is described below.

FIG. 16 is a flowchart illustrating an inspection flow using a multi-head model forming a defect inspection system according to the third embodiment of the invention. First, the inspection area of the sample 107 to be inspected is scanned with the charged particle beam 103, and the acquired inspection target image is stored in the inspection target image DB 322 (FIG. 1) (step S701). Next, in step S702, the defect inspection unit 330b reads the image to be inspected from the inspection target image DB 322 (FIG. 1). Then, in step S703, the defect inspection unit 330b reads the internal parameters of the multiple non-defective product image estimation model 401 from the learned parameter DB 323 (FIG. 1). In step S704, the defect inspection unit 330b inputs the inspection target image to the multiple non-defective product image estimation model 401 with the internal parameters read, and outputs a plurality of estimated non-defective product images. In step S705, the defect inspection unit 330b performs statistical processing on the plurality of estimated non-defective product images 440 to create a single integrated estimated non-defective product image. In step S706, the defect inspection unit 330b creates a difference image by performing comparison processing between the inspection target image and the integrated estimated non-defective product image in order to extract defective parts. In step S707, the defect inspection unit 330b performs false report discrimination processing on the difference image to output a defect map showing the defective parts (step S708).

FIG. 17 is a diagram illustrating an example of defect image inspection using integration processing of estimated non-defective product images by the defect inspection unit 330b illustrated in FIG. 1. The multiple non-defective product image estimation model 401 includes three non-defective product image estimation models 400 (not illustrated), and an example will be described in which three estimated non-defective product images 440 are output for one inspection target image 1000. The defect inspection unit 330b obtains three estimated non-defective product images 440 by inputting the inspection target image 1000 to the multiple non-defective product image estimation model 401 of internal parameters are read from the learned parameter DB 323. The three non-defective product image estimation models 400 (not illustrated) have different internal parameters, so three different estimated non-defective product images 440 are output. Next, the three estimated non-defective product images 440 are subjected to statistical processing to generate an integrated estimated non-defective product image 1702 that shows the median value of pixel values at the same position in the three estimated non-defective product images 440 (median processing 1701). Next, the inspection target image 1000 and the integrated estimated non-defective product image 1702 are compared (1703) to generate a difference image 1002. False report discrimination processing 1704 is performed on the difference image 1002 to output a defect map 1004 that shows defective parts. The statistical processing used when integrating the estimated non-defective product images may be the average value, the most frequent value, or the maximum value.

As described above, according to this embodiment, in addition to the effects of the first embodiment, by performing comparison processing and false report discrimination processing using integrated images, false report discrimination processing can be performed using reproducible results, making it possible to achieve higher accuracy.

### Fourth Embodiment

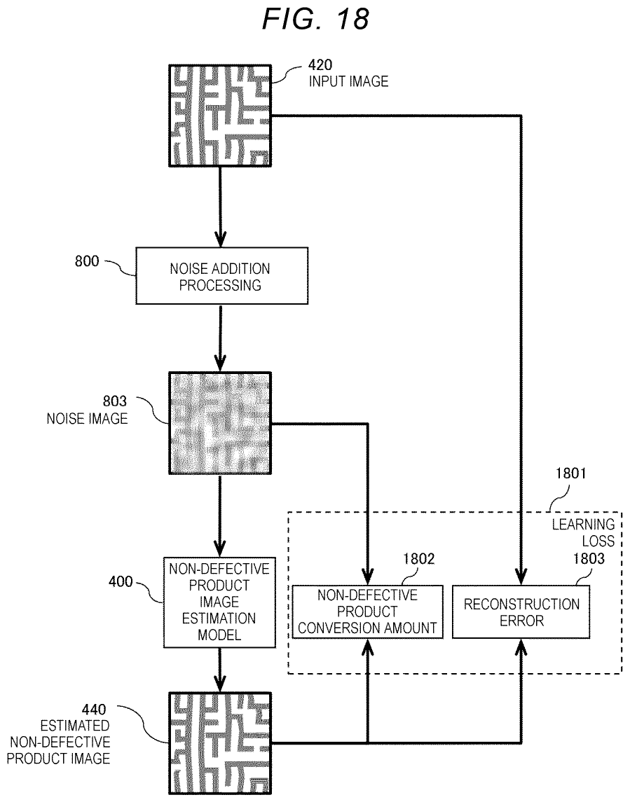

A fourth embodiment will be described with reference to FIG. 18. A basic configuration of the fourth embodiment is similar to and common to that of the first embodiment, and the following mainly describes the configuration parts of the fourth embodiment that are different from the first embodiment. In the fourth embodiment, a learning loss 1801 calculation in the training flow of the non-defective product image estimation model 400 uses not only the reconstruction error but also the non-defective product conversion amount. A specific example will be described below.

FIG. 18 is a diagram illustrating an example of training of a non-defective product image estimation model 400 using maximization of a non-defective product conversion amount by a learning unit 330a forming a defect inspection system 1 according to a fourth embodiment of the invention. As illustrated in FIG. 18, the internal parameters of the multiple non-defective product image estimation model 401 are learned by minimizing a squared error between the input image 430 and the estimated non-defective product image 440 and maximizing a squared error between the noise image and the estimated non-defective product image. A reconstruction error 1803 is learned to output the estimated non-defective product image 440 for each input image 430. However, when the defect in the inspection target image is minute during inspection, even when the non-defective product image can be correctly estimated, a difference value with the inspection target image is small, so that it is erroneously determined to be a false report in the false report discrimination processing. When the non-defective product image estimation model 400 is trained to maximize a squared error between the noise image 803 and the estimated non-defective product image 440, the model will output an image in which the noise image is converted as much as possible. However, when training is performed only by maximizing a non-defective product conversion amount 1802, it will try to convert the noise image 803 as much as possible, and will end up training to output an estimated non-defective product image 440 that is far from the input image 430. By training by combining the minimization of the reconstruction error 1803 and the maximization of the non-defective product conversion amount 1802, it is possible to learn to output an image in which non-defective parts remain as the non-defective parts and defective parts have a difference value larger than a difference value from a corresponding original non-defective product pattern. As a result, the difference value of the defective parts becomes larger in comparison processing, stability of the extraction of the defective parts increases, and reproducibility of a final inspection result is improved.

As described above, according to this embodiment, in addition to the effects of the first embodiment, the difference value of the defective parts becomes larger in the comparison processing, the stability of the extraction of the defective parts increases, and the reproducibility of the final inspection result can be improved.

### Fifth Embodiment

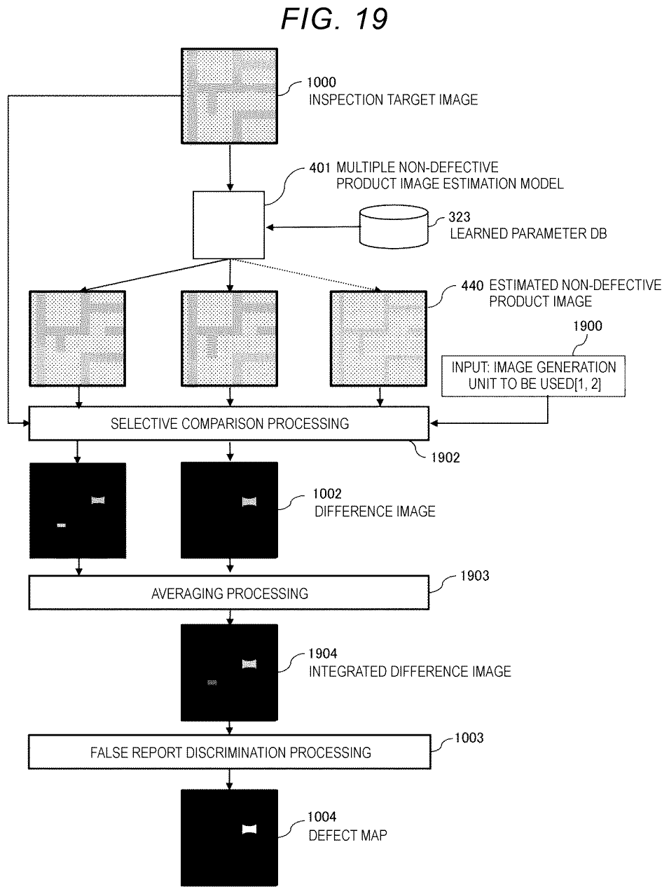

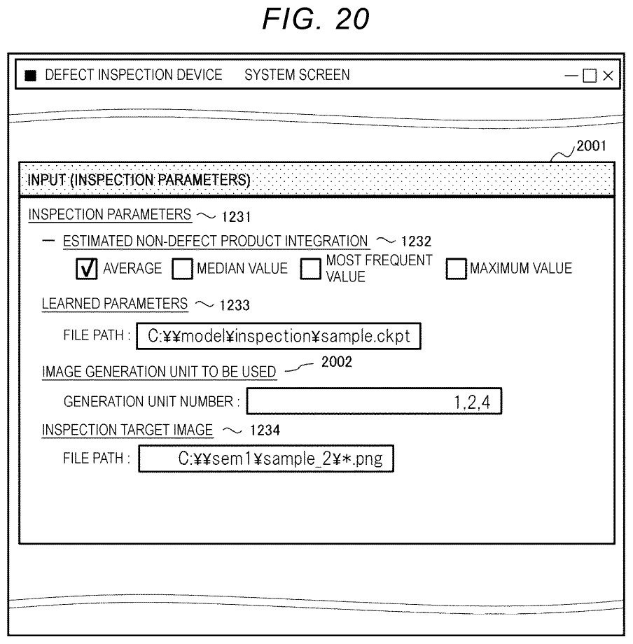

A fifth embodiment will be described with reference to FIGS. 19 and 20. A basic configuration of the fifth embodiment is similar to and common to that of the first embodiment, and the following mainly describes configuration parts of the fifth embodiment that are different from the first embodiment. In the fifth embodiment, in an inspection flow of the non-defective product image estimation model 400, not all of a plurality of estimated non-defective product images 440 are used, but only some of the estimated non-defective product images 440 are selectively used. A specific example will be described below.

FIG. 19 is a diagram illustrating an example of inspection processing using selection of an estimated non-defective product image 440 by a defect inspection unit 330b forming a defect inspection system according to the fifth embodiment of the invention. The multiple non-defective product image estimation model 410 includes three non-defective product image estimation models 400 (not illustrated), and an example will be described in which three estimated non-defective product images 440 are output for one inspection target image 1000. The defect inspection unit 330b obtains three estimated non-defective product images 440 by inputting the inspection target image 1000 to the multiple non-defective product image estimation model 401 of which internal parameters are read from the learned parameter DB 323. The three non-defective product image estimation models 400 (not illustrated) have different internal parameters, so three different estimated non-defective product images 440 are output. Next, the inspection target image 1000, all estimated non-defective product images 440, and parameters 1900 indicating the image generation unit to be used are input to comparison processing 1902. The comparison processing 1902 excludes estimated non-defective product images 440 output from image generation units other than the specified one from the processing target, and creates a difference image 1002 of the inspection target image 1000 and the estimated non-defective product image 440. When parameters indicating 1 and 2 are input as the image generation units to be used, the estimated non-defective product image 440 output from the image generation unit 420 is excluded from the processing target. Statistical processing is performed on the difference image 1002 created by the comparison processing 1902 to create an integrated difference image 1904 indicating an average value of the pixel values at the same position in the difference image 1002. Next, false report discrimination processing 1003 is performed on the integrated difference image 1904 to output a defect map 1004 indicating defective parts. The image generation unit 1900 to be used may be switched for each inspection area. When a specific image generation unit included in the multiple non-defective product image estimation model 401 cannot output an appropriate estimated non-defective product image 440 for the pattern of a part of the inspection area, false reports during inspection can be suppressed.

FIG. 20 is a diagram illustrating an example of a GUI of the display device illustrated in FIG. 1, and is a diagram illustrating a display screen of the GUI for selecting an estimated non-defective product image. As illustrated in FIG. 20, the GUI according to this embodiment has an input field 2001 for inspection parameters. The input field 2001 for inspection parameters includes an input field 1232 for estimated non-defective product integration, an input field 1233 for learned parameters of the multiple non-defective product image estimation model 401, an input field 2002 for an image generation unit to be used, and an input field 1234 for an inspection target image. In the input field 2002 for the image generation unit to be used, a number of the image generation unit to be used in the comparison processing of the inspection processing flow is input.

As described above, according to this embodiment, in addition to the effect of the first embodiment, when some models included in the multiple non-defective product image estimation model have failed to learn, the accuracy of the final inspection result decreases. Therefore, by using the output of only well-learned models, it is possible to further improve the accuracy.

The invention is not limited to the above-described embodiments, and includes various modification examples. For example, the above-described embodiments are described in detail to described the invention in an easy-to-understand manner, and are not necessarily limited to those including all of the configurations described. Furthermore, it is possible to replace a part of the configuration of one embodiment with the configuration of another embodiment, and it is also possible to add the configuration of another embodiment to the configuration of one embodiment.

Furthermore, the above-described configurations, functions, processing units, processing means, and the like may be realized in part or in whole in hardware, for example by designing them as integrated circuits. The above-described configurations, functions, and the like may be realized in software by a processor interpreting and executing programs that realize each function. Information such as programs, tables, files, and the like that realize each function can be stored in a memory, a recording device such as a hard disk or a Solid State Drive (SSD), or a recording medium such as an IC card, an SD card, or a DVD.

In addition, the control lines and information lines illustrated are those considered necessary for the description, and not all control lines and information lines in the product are necessarily illustrated. In reality, it can be assumed that almost all components are interconnected.

What is claimed is:

1. A defect inspection system having an imaging device for acquiring an observation image of a sample, comprising:
a learning unit that trains a multiple non-defective product image estimation model that captures an image of the sample to acquire a learning image and estimates a plurality of non-defective product images of the sample for one input image using the learning image; and
a defect inspection unit that captures an image of an inspection target sample using the imaging device to acquire an inspection target image, inputs the inspection target image into the multiple non-defective product image estimation model trained, outputs a plurality of estimated non-defective product images corresponding to the inspection target image, and extracts a defective part using the plurality of estimated non-defective product images.

2. The defect inspection system according to claim 1, wherein
the multiple non-defective product image estimation model has a plurality of non-defective product image estimation models.

3. The defect inspection system according to claim 1, wherein
the multiple non-defective product image estimation model includes an image feature extraction unit in common and a plurality of image generation units that generate a single non-defective product image based on an output of the image feature extraction unit.

4. The defect inspection system according to claim 2, wherein
the defect inspection unit creates a single integrated estimated non-defective product image from the plurality of estimated non-defective product images using statistical processing, and compares the inspection target image with the integrated estimated non-defective product image to extract the defective part.

5. The defect inspection system according to claim 2, wherein
the defect inspection unit compares the inspection target image with each of the plurality of estimated non-defective product images, creates a defect map that is an image showing the defective part, performs statistical processing on a plurality of the defect maps, and outputs an integrated defect map.

6. The defect inspection system according to claim 4, wherein
the statistical processing creates an image showing at least one of an average, a median value, a most frequent value, and a maximum value of pixel values at the same position on a plurality of images to be processed.

7. The defect inspection system according to claim 1, wherein
the learning unit repeatedly updates internal parameters of the multiple non-defective product image estimation model so as to minimize a reconstruction error, which is a difference between the learning image and an estimated non-defective product image estimated from a noise image obtained by adding a defective product feature to the learning image, and the learning image is a non-defective product image.

8. The defect inspection system according to claim 7, wherein
the learning unit repeatedly updates the internal parameters of the multiple non-defective product image estimation model so as to minimize the reconstruction error and maximize a non-defective product conversion amount of the noise image to the estimated non-defective product image.

9. The defect inspection system according to claim 1, wherein
the learning unit performs at least one of brightness conversion, contrast conversion, and distortion addition on the learning image before inputting the learning image into the multiple non-defective product image estimation model.

10. The defect inspection system according to claim 1, wherein
the defect inspection unit extracts the defective part using some of the estimated non-defective product images among the plurality of estimated non-defective product images.

11. The defect inspection system according to claim 6, comprising:
a display device, wherein
the display device has an input field for inputting the number of estimated non-defective product images to be output from the multiple non-defective product image estimation model on a screen.

12. A defect inspection method for a defect inspection system having an imaging device for acquiring an observation image of a sample, comprising the steps of:
training, with a learning unit, a multiple non-defective product image estimation model that captures an image of the sample to acquire a learning image and estimates a plurality of non-defective product images of the sample for one input image using the learning image; and
capturing, with a defect inspection unit, an image of an inspection target sample using the imaging device to acquire an inspection target image, inputting the inspection target image into the multiple non-defective product image estimation model trained, outputting a plurality of estimated non-defective product images corresponding to the inspection target image, and extracting a defective part using the plurality of estimated non-defective product images.

13. The defect inspection method according to claim 12, wherein
the multiple non-defective product image estimation model has a plurality of non-defective product image estimation models.

14. The defect inspection method according to claim 13, comprising the steps of:
creating, with the defect inspection unit, a single integrated estimated non-defective product image from the plurality of estimated non-defective product images using statistical processing; and
comparing, with the defect inspection unit, the inspection target image with the integrated estimated non-defective product image to extract the defective part.

15. The defect inspection method according to claim 13, comprising the steps of:
comparing, with the defect inspection unit, the inspection target image with each of the plurality of estimated non-defective product images to create a defect map that is an image showing a defective part; and
performing, with the defect inspection unit, statistical processing on a plurality of the defect maps to output an integrated defect map.
